(19) United States
(12) Patent Application Publication
(10) Pub. No.: US 2008/0126658 A1
(43) Pub. Date: May 29, 2008

(54) INLAYED FLASH MEMORY MODULE

(75) Inventor: Chih-Ling Wang, Chutung Town (TW)

Correspondence Address: PHISON ELECTRONICS CORPORATION, 2F-4. NO. 148, SEC. 4, CHUNG HSIAO EAST ROAD, TAIPEI, omitted

(73) Assignee: PHISON ELECTRONICS CORP., Chutung Town (TW)

(21) Appl. No.: 11/420,763

(22) Filed: May 28, 2006

(51) Int. Cl. G06F 13/00

(52) U.S. Cl. 710/302

(57) ABSTRACT

An inlayed flash memory module suitable for being directly welded or inlayed on a printed circuit board via a pad interface connection is disclosed. The flash memory module comprises a flash memory and a circuit board. The flash memory has at least one or a plurality of blocks for storing data. The circuit board comprises a flash memory controller and a plurality of interface connecting points. The flash memory controller is adopted for interacting with a host and controlling the blocks in the flash memory, and the interface connecting points are directly welded or inlayed on the circuit board. Thus, the need of a connector for memory card can be eliminated.

### BACKGROUND OF THE INVENTION

1. Field of Invention

The present invention generally relates to an inlayed flash memory module, and more particularly a flash memory controller and a flash memory, the flash memory and elements on the circuit board are modulized, and the flash memory module is directly welded or inlayed on the printed circuit board via a pad interface connection and thereby simplify the firmware design and program and reduce the cost.

2. Description of the Related Art

The inlayed memories are mostly comprised of DRAM, SRAM and SDRAM. These memory modules are used as standard components in personal computer for years and peripheral hardware is accordingly designed. The multi-media player, portable ROM, MP3, PDA, mobile phone, digital camera or digital video camera all use flash memory. However, a variety of flash memories are produced in a variety of sizes and shapes by various manufacturers. Examples of memory cards include MMC, CF, SMC, MS and SD. Flash memory doesn't have any related modulized hardware such as the DRAM or FM module.

Furthermore, even though devices such as multi-media player, portable ROM, MP3, PDA, mobile phone, digital camera or digital video camera employing the flash memory cards are modulized, a variety of the memory cards use connectors with different specifications and the circuit thereof are designed accordingly. Therefore, the cost of the hardware is high. Referring to FIG. 1, a conventional MP3 player A comprises a display module A1, a MP3 decoder, a flash memory controller A2 and a memory chip A3. The memory chip A3 is welded on the printed circuit board of the MP3 player A in a package. The MP3 decoder and memory controller A2 comprise several electrical connection signals with the memory chip A3. The firmware program has to be designed according to the variety of the flash memories. Thus, designing of the program requires longer time and therefore is uneconomical. Taking the above MP3 player 3 as the example, the MP3 player A can be a multi-media player, portable ROM, MP3, PDA, mobile phone, digital camera or digital video camera.

Therefore, how to overcome the above defect is an important issue for manufacturers in the field.

### SUMMARY OF THE INVENTION

According to an aspect of the present invention, the flash memory module, having a plurality of interface connecting point disposed on a circuit board via pad connection, is directly welded or inlayed on a printed circuit board. The interface connecting points have at least one power connecting point, a ground connecting point, a signal control connecting point and a data transmission connecting point. Thus, a designer of the hardware and the firmware can eliminate the need of a connector for a memory card and thereby greatly simplify the circuit design and the program, and reduce the cost. Thus, making the application flash memory module more popular.

### BRIEF DESCRIPTION OF THE DRAWING

FIG. 1 is a block diagram of a conventional MP3.

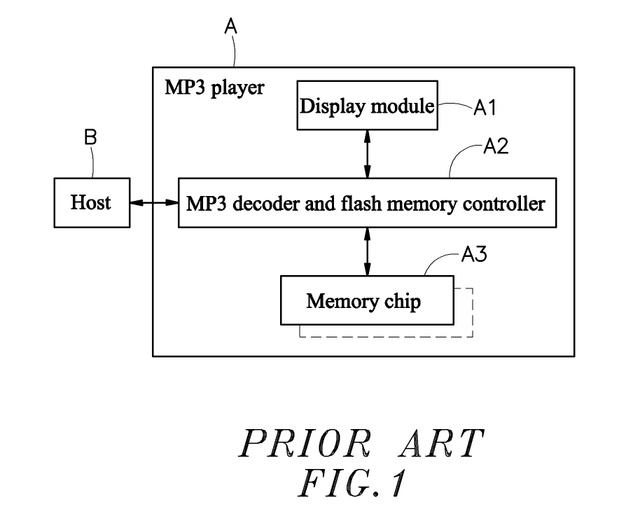

FIG. 2 is a block diagram of an inlayed flash memory module according to an embodiment of the present invention.

FIG. 3 is a block diagram showing the application of the inlayed flash memory module of the present invention in a MP3.

### DETAILED DESCRIPTION OF THE EMBODIMENTS

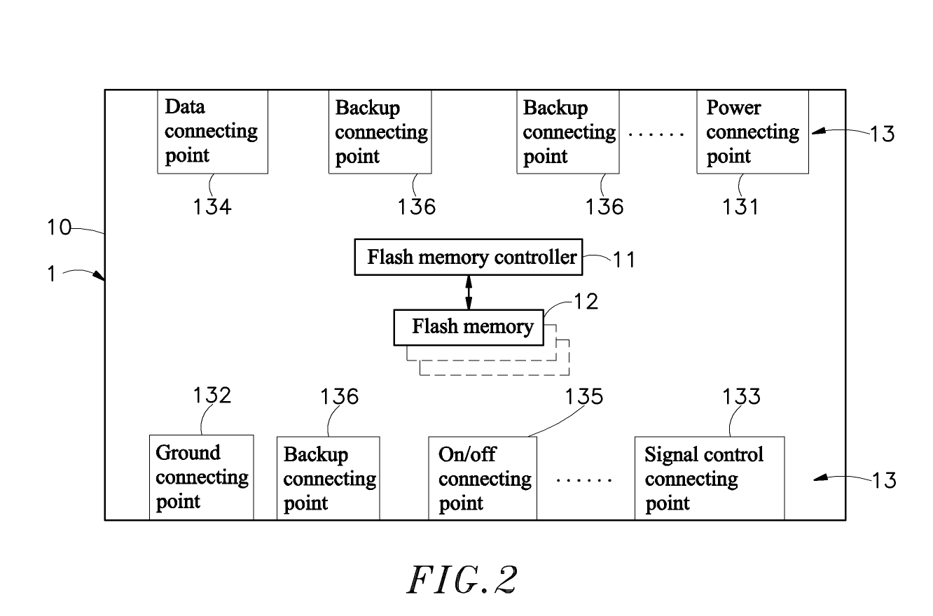

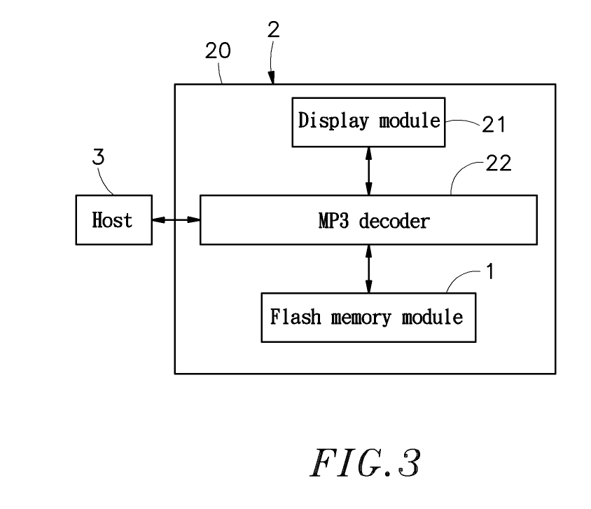

Referring to FIGS. 2 and 3, a flash memory module 1 comprises a circuit board 10 having a flash memory controller 11, a flash memory 12 and a plurality of interface connecting points 13. The flash memory controller 11 is adopted for interacting with a host 3 and controlling at least one or a plurality of blocks in the flash memory 12. The blocks in the flash memory 12 are adopted for storing data. The interface connecting points 13 disposed on the circuit board 10 of the flash memory module 1 has at least a power connecting point 131 for connecting a power supply interface, a ground connecting point 132 for connecting a ground interface, a signal control connecting point 133 for connecting a system signal control interface and a data transmission connecting point 134 for connecting a data transmission interface. Furthermore, the interface connecting point 13 further comprises an on/off connecting point 135 for connecting a system on/off interface and a plurality of backup connecting points 136 for connecting with new interfaces for expansion purpose. The interface connecting point 13 of the flash memory module 1 is formed as the pad, which can be directly welded or inlayed on a printed circuit board 20 of a MP3 player 2.

The flash memory controller 11 may be a SD controller, a MMC controller, a MS controller, a RS-MMC controller, a RS-MOBILE controller or a CF controller. The flash memory 12 may be a NAND flash memory, an AG-AND flash memory or a NOR flash memory.

Referring to FIG. 2 and 3, a display module 21 and a MP3 decoder 22 are welded on the printed circuit board 20 of the MP3 player 2, and the flash memory module 1 is directly welded or inlayed on the printed circuit board 20 of the MP3 player 2 at the same time. The interface connecting point 13 of the flash memory module 1 is connected to the MP3 decoder 22 and the display module 21, namely, the flash memory module 1 may be connected to the MP3 decoder 22 via the interface connecting point 13, and the MP3 decoder 22 is connected to the host 3.

Referring to FIG. 2 again, the inlayed flash memory module 1 and the flash memory controller 11 may be packaged using QFN, LGA, BGA, LQFP, QFP, DIE, COB or SIP packaging process. Thus, the need of a connector for a memory card may be eliminated and thereby reduce the cost.

Referring to FIG. 2 again, the inlayed flash memory module 1 and the flash memory 12 may be packaged using QFN, LGA, BGA, LQFP, QFP, DIE, COB or SIP packaging process. Thus, the need of a connector for a memory card may be eliminated and thereby reduce the cost.

Furthermore, the interface connecting point 13 of the flash memory module 1 may be directly welded or inlayed on the printed circuit board 20 of the MP3 player 2 using a PAD method. The MP3 player 2 according to an embodiment of the present invention described above is used only for demonstrating the present invention. Instead of the MP3 player 2, the present invention may also be applied in multi-media player, portable ROM, MP3, PDA, cellular phone, digital camera, digital video camera or other digital devices. The flash memory module 1 of the present invention significantly simplifies the hardware of various digital system devices such that the need of a connector for a memory card may be eliminated and thereby reduces the cost. In addition, a firmware designer can also simplify the program by using the modularized structure of the present invention.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. An inlayed flash memory module comprising a flash memory having at least one or a plurality of blocks for storing data, suitable for being directly welded or inlayed on a printed circuit board via a pad interface connection, said flash memory module comprising:
a circuit board, comprising:
a flash memory controller, for interacting with a host and controlling said blocks in said flash memory; and
a plurality of interface connecting points, directly welded or inlayed via a pad interface connection on said circuit board, comprising at least a power connecting point, a ground connecting point, a signal control connecting point and a data transmission connecting point.

2. The inlayed flash memory module according to claim 1, wherein said flash memory controller comprises a SD controller, a MMC controller, a MS controller, a RS-MMC controller, a RS-MOBILE controller or a CF controller.

3. The inlayed flash memory module according to claim 1, wherein said flash memory comprises a NAND flash memory, an AG-AND flash memory or a NOR flash memory.

4. The inlayed flash memory module according to claim 1, wherein said flash memory controller can be packaged using QFN, LGA, BGA, LQFP, QFP, DIE, COB or SIP packaging methods.

5. The inlayed flash memory module according to claim 1, wherein said flash memory can be packaged using QFN, LGA, BGA, LQFP, QFP, DIE, COB or SIP packaging methods.
